(19) United States
(12) Patent Application Publication
(10) Pub. No.: US 2006/0061688 A1
(43) Pub. Date: Mar. 23, 2006

(54) Apparatus and method for switching channel of digital television

(75) Inventor: Jong In Choi, Gyeonggi-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/228,590

(22) Filed: Sep. 15, 2005

(30) Foreign Application Priority Data
Sep. 17, 2004 (KR) 10-2004-0074474

(51) Int. Cl. H04N 9/74; H04N 5/50

(52) U.S. Cl. 348/588; 348/731

(57) ABSTRACT

An apparatus and method for switching a channel of a digital television is disclosed. The apparatus for switching a channel of the digital TV comprises a image processor for performing scaling of image data input to match an output image size; a frame storage unit for storing the image frames scaled by the image processor; and a controller for allowing a image frame of a first channel and a image frame of a second channel scaled by the image processor to be displayed as a single image. Therefore, the apparatus allows a window on a screen to be slid and results in minimization or a user eyestrain caused by a channel switching operation.

### CROSS REFERENCE TO RELATED APPLICATIONS

This application claims the benefit of Korean Patent Application No. P2004-0074474, filed on Sep. 17, 2004, which is hereby incorporated by reference as if fully set forth herein.

### BACKGROUND OF THE INVENTION

1. Field of the Invention

The present invention relates to an apparatus and method for switching a channel of a digital television, and more particularly to an apparatus and method for switching a channel of a digital TV, which allows an image received over a switched channel to be naturally displayed, and minimizes fatigue of user's eyes when performing a channel switching operation.

2. Discussion of the Related Art

Generally, a digital TV has widely used a display panel capable of displaying a desired image at a high brightness and a high contrast ratio to obtain a superior image quality.

Particularly, if a user or TV viewer views a broadcast program via a very bright display panel at night, the user or TV viewer may experience eyestrain. Specifically, a black image between channels may unexpectedly cause the user or TV viewer more stress.

FIG. 1 shows an exemplary image displayed when a conventional digital TV switches a current channel to another channel.

If the user or TV viewer who views a broadcast program of a first channel associated with the image of FIG. 1(a) switches the first channel to a second channel to view another broadcast program of a second channel associated with the image of FIG. 1(c), a display panel outputs a black image of FIG. 1(b) at a specific time between a first image display time of the image shown in FIG. 1(a) and a second image display time of the image shown in FIG. 1(b).

In other words, if the user or TV viewer views a broadcast program of the digital TV at a dark place, a current channel image and the next channel-switched image are alternately turned on or off, such that a bright image and a dark image are alternately displayed on the TV within a very short time, resulting in the occurrence of eyestrain.

### SUMMARY OF THE INVENTION

Accordingly, the present invention is directed to an apparatus and method for switching a channel of a digital TV that substantially obviates one or more problems due to limitations and disadvantages of the related art.

An object of the present invention is to provide an apparatus and method for switching a channel of a digital TV, which allows an image of the current channel to be naturally switched to an image of the switched channel when a current channel is switched to another channel, and minimizes of user's eyes.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for switching a channel of a digital television comprises image processor for performing scaling of image data input to match an output image size; a frame storage unit for storing the image frames scaled by the image processor; and a controller for allowing a image frame of a first channel and a image frame of a second channel scaled by the image processor to be displayed as a single image.

And preferably, An apparatus for switching a channel of a digital television may comprise a first image processor for performing scaling of first video data of a first channel to match an output image size, and generating the first video data in the form of a plurality of first image frames; a second image processor for performing scaling of second video data of a switched channel, and generating the second video data in the form of a plurality of second image frames; a frame storage unit for storing the first image frames scaled by the first image processor and the second image frames scaled by the second image processor; and a controller for allowing a first image frame scaled by the first image processor and a second image frame scaled by the second image processor to be displayed as a single image.

Preferably, the channel switching apparatus may further comprise a window synthesizer for synthesizing the scaled first image frame and the scaled second image frame in a single image, and generating the synthesized image.

Preferably, the synthesized image generated from the window synthesizer may include a first image indicative of one of a moving image and a still image.

Preferably, the synthesized image generated from the window synthesizer may include a second image indicative of one of a moving image and a still image.

Preferably, the synthesized image generated from the window synthesizer for synthesizing the first image and the second image is implemented with a sliding method by which by which the first image is slid out of a screen and the second image is slid in a screen.

Preferably, the synthesizing of the window synthesizer for synthesizing the first image and the second image may be implemented with a fade-in and fade-out method by which the first image is faded out and the second image is then faded in.

Preferably, the first image processor may store the first image frames in the frame storage unit using a first image writing pointer.

Preferably, the first image processor may read the first image frames stored in the frame storage unit using a first image reading pointer, and displays the read first image frames.

Preferably, the second image processor may store the second image frames in the frame storage unit using a second image writing pointer.

Preferably, the second image processor may read the second image frames stored in the frame storage unit using a second image reading pointer, and displays the read second image frames.

Preferably, the controller may control I/O (Input/Output) position information, I/O size information of a first image frame and a second image frame, and writing/reading pointers of a first image and a second image, such that the first image and the second image are displayed on a single screen.

In another aspect of the present invention, a method for switching a channel of a digital television includes the steps of (a) performing scaling of first video data of a current channel to match an output image size, and storing the first video data in the form of a plurality of first image frames; (b) performing scaling of second video data of a switched channel, and storing the second video data in the form of a plurality of second image frames; and (c) synthesizing one of the first image frames and one of the second image frames, and displaying the synthesized image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows an exemplary image displayed when a conventional digital TV switches a first channel to a second channel;

FIG. 2 is a block diagram illustrating a channel switching apparatus according to the present invention;

FIG. 3 shows positions of main/sub images displayed when a first channel is switched to a second channel using a sliding scheme according to the present invention;

FIG. 4 shows a method for operating a frame storage unit when a first image is changed to a still image during a channel switching operation according to the present invention;

FIG. 5 shows a method for operating a frame storage unit when a first image is implemented with a moving image during a channel switching operation according to the present invention; and

FIGS. 6A to 6C show a variety of preferred embodiments associated with channel switching types according to the present invention.

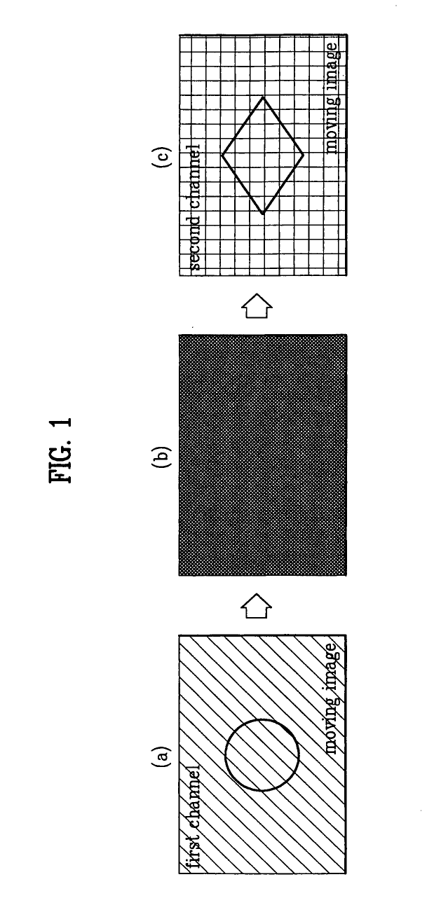

### DETAILED DESCRIPTION OF THE INVENTION

Reference will now be made in detail to the preferred embodiments of the present invention, examples of which are illustrated in the accompanying drawings.

Prior to describing the present invention, it should be noted that a current channel which a user is watching be referred as a first channel, and a channel switched from the first channel be referred as a second channel. Also, it should be noted that an image displayed on a screen of a first channel be referred to as a first image, and an image displayed on a screen of a switched channel when the first channel is switched to another channel be referred to as a second image.

In accordance with the purpose of the invention, a image processor of an apparatus for switching a channel may comprise a first image processor for processing the first channel signal and a second image processor 400 for processing the second channel signal, preferably.

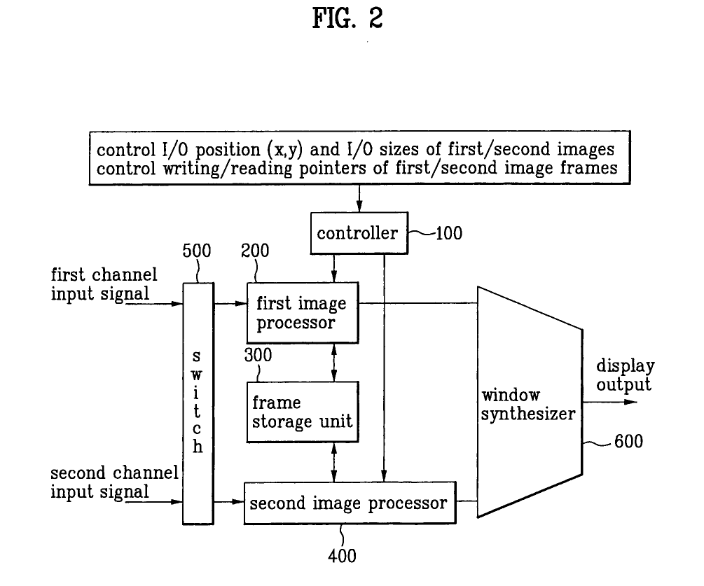

FIG. 2 is a block diagram illustrating a channel switching apparatus according to the present invention.

Referring to FIG. 2, the channel switching apparatus according to the present invention includes a switch 500 for receiving a signal of a first channel and a signal of a second channel to be selected later, and selectively generating the first channel signal or the second channel signal; a first image processor 200 for processing the first channel signal; a second image processor 400 for processing the second channel signal to be selected later; a frame storage unit 300 for storing the first image acting as the first channel signal and the second image acting as the second channel signal in frame units; a controller 100 for transmitting I/O (Input/Output) position information and output size information of the first/second images, and writing/reading pointers of the first/second image frame storage unit 300 to the first image processor 200 and the second image processor 400; and a window synthesizer 600 for integrating two images into a single output image.

Operations of the channel switching apparatus including the above-mentioned components will hereinafter be described.

Firstly, an input signal of the first channel (i.e., the first channel signal) selected by a user who views a broadcast program associated with the first channel signal is applied to the first image processor 200 by the switch 500.

The first image processor 200 performs scaling of video data of the input signal to match the size of an output image, and stores the scaled video data in the frame storage unit 300 in frame units.

The first image processor 200 reads the video data stored in the frame storage unit 300 in frame units, and displays the read video data on a screen via the window synthesizer 600.

If a user or TV viewer who views the resultant image processed by the above-mentioned method switches a first channel to a second channel, the second channel signal acting as an input signal of the switched channel is applied to the second image processor 400 via the switch 500.

The second image processor 400 performs scaling of the image applied to the second channel to match the size of the output image, and stores the scaled video data in the frame storage unit 300 in frame units.

The second image processor 400 re-reads the video data stored in the frame storage unit 300, and transmits the read video data to the window synthesizer 600. The window synthesizer 600 displays the video data on a screen.

A channel switching apparatus according to a preferred embodiment of the present invention allows a first image acting as the first channel input signal to be naturally switched to a second image acting as the second channel input signal according to a sliding scheme when a user switches a first channel to a second channel.

In order to perform the above-mentioned channel switching operation, the controller 100 controls I/O positions (x,y) and I/O sizes of the first/second images, and controls reading/writing pointers associated with the first/second images stored in the frame storage unit 300 using the first/second image processors 200 and 400.

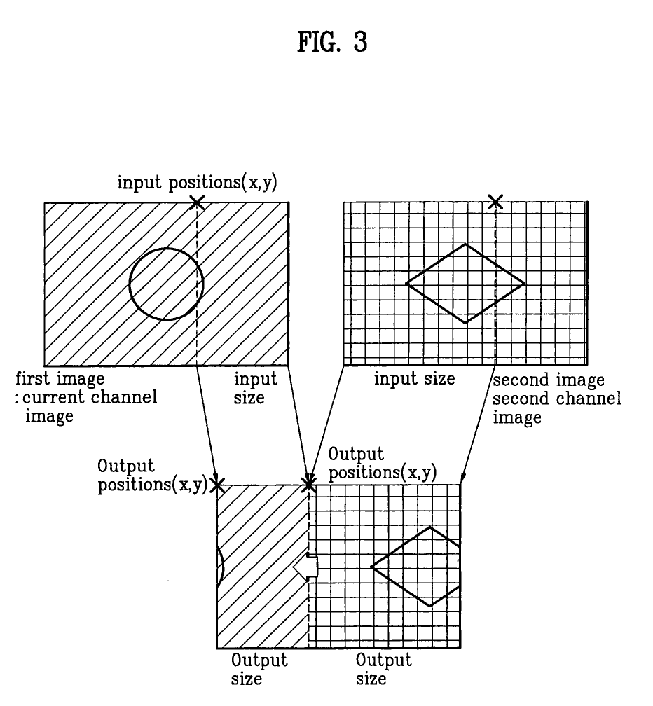

FIG. 3 exemplarily shows a method for controlling the I/O positions (x,y) and I/O sizes of first/second images using the controller 100 according to the present invention.

The circle and the quadrangle in the FIG. 3 mean a video image displayed on a screen, and all of them may be one of a moving image and a still image although all of them looks like fixed geometric figures.

A method for controlling the first/second images using the controller 100 will hereinafter be described with reference to FIG. 3.

The first image processor 200 can have some parts of the first image, which is associated with the first channel displayed using position and size information of its input image. In this way, the second image processor 400 can have some parts of the second image, which is associated with a switched channel, displayed using position and size information of its input image

If the user switches the current channel to another channel according to the sliding method, the controller 100 transmits an input size of a first image reduced in a predetermined sliding direction while being currently displayed on a monitor (hereinafter referred to as a first input size), an input size of a second image acting as a channel-switched image (hereinafter referred to as a second input size), and input positions (x,y) (hereinafter referred to as a first input position and a second input position respectively) indicative of individual start points of the first image having the first input size and the second image having the second input size to the first image processor 200 and second image processor 400 in real time.

If the channel switching is performed, the first input position is set to a first output position of a displayed image, and a first image, formed prior to the channel switching simultaneously with having a first output size, is displayed at a predetermined range from the first output position. Simultaneously, the second input position is set to a second output position, and a second image having a second output size is displayed at a predetermined range from the second output position.

The first image formed prior to the channel switching is reduced in a direction of an arrow marked on a screen of FIG. 3 is decreased, but the second image formed after the channel switching is increased.

The output image displayed on the screen using the above-mentioned method includes the first image displayed prior to the channel switching and the second image displayed after the channel switching. A sliding operation between the first and second images is actively performed to achieve the channel switching.

In order to display the first image and the second image on a single screen at the same time, reading/writing control operations for first image data and second image data stored in the frame storage unit 300 are required.

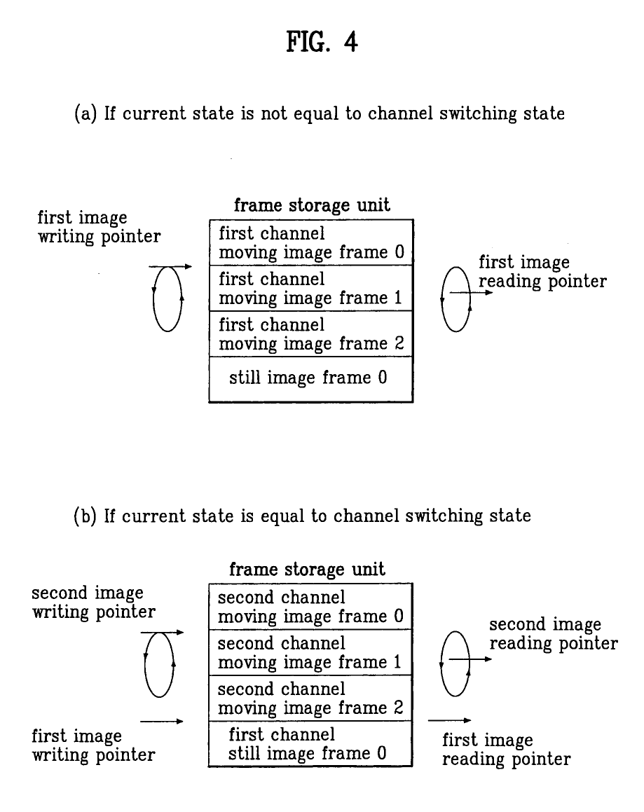

The channel switching apparatus according to the present invention can enable a first channel image displayed for the user to enter a still image at a channel switching moment, and can switch the first channel to a second channel. FIG. 4 shows a method for operating the frame storage unit at the channel switching moment according to the present invention.

FIG. 4(a) shows a method for operating the frame storage unit when a current state is not equal to a channel switching state.

The channel switching apparatus according to the present invention stores a plurality of moving image frames of a first image into a plurality of frame areas in the frame storage unit 300.

The channel switching apparatus according to the present invention pre-stores a single frame and its successive frames in moving image frame storage areas, reads frames stored in the moving image frame storage areas according to the stored frame sequence, and displays the read frames on a screen.

Therefore, moving image frames currently displayed for the user are stored in two or more frame storage areas according to the processing sequence of the moving images.

FIG. 4(b) shows a method for operating the frame storage unit when a current state is equal to a channel switching state.

As can be seen from FIG. 4(b), if the channel switching state is provided by a user request when reading/writing operations of the moving image frames of a first image are repeated in a plurality of frame storage areas, the method for operating the frame storage unit may be employed as shown in FIG. 4(b).

If a first channel is switched to a second channel, the controller 100 controls the first image processor 200 to record or write the last frame of a first image in a still image frame storage area of the frame storage unit using the reading/writing pointer of the first image frame.

The controller 100 controls the second image processor 400 to record or write a plurality of moving image frames of a second channel image in moving image frame storage areas of the frame storage unit using the reading/writing pointer of the second image frame.

The controller 100 controls the second image processor 400 to sequentially read the stored moving image frames associated with a second channel using a second image reading pointer, such that the moving image frames are sequentially displayed on the screen.

In this case, the controller 100 controls the first image processor 200 to simultaneously display the last frame stored in the still image frame storage area using a first image reading pointer and the second image using a second image reading pointer during a predetermined time.

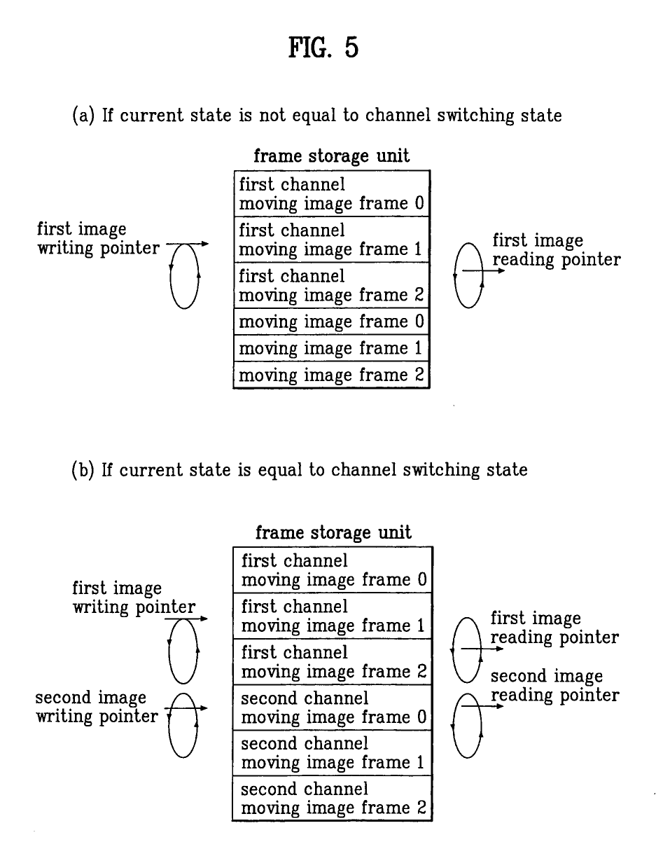

The channel switching apparatus according to the present invention can allow a first channel image to be implemented with a moving image during the channel switching operation. A method for operating the frame storage unit when a first image is implemented with the moving image during the channel switching operation will hereinafter be described with reference to FIG. 5.

FIG. 5(a) shows a method for operating the frame storage unit when a current state is not equal to a channel switching state.

If the current state is not equal to the channel switching state, a plurality of moving image frame storage areas are pre-stored in the frame storage unit, and the stored frames are displayed according to the stored sequence of the moving image frame areas in the same manner as in FIG. 4(a).

Therefore, the moving image frames are displayed on the screen in the order of the moving image frame 0→the moving image frame 1→the moving image frame 2→ . . . of a first channel, as shown in FIG. 5(b).

FIG. 5(b) shows a method for operating the frame storage unit when a current state is equal to a channel switching state.

If a first channel is switched to a second channel, a plurality of frame storage areas for displaying a second image are additionally provided, such that a second channel image can maintain a moving image state.

If a first channel is switched to a second channel, the controller 100 controls the first image processor 200 to record or write moving image frames of a previous image formed prior to the channel switching in moving image frame storage areas of the frame storage unit using the reading/writing pointer of the first image frame.

The first image processor 200 displays the recorded moving image frames of the first channel prior to the channel switching using the reading pointer of the first image frame on a screen.

The controller 100 controls the second image processor 400 to record or write a plurality of moving image frames associated with a second channel in the moving image frame storage areas using the reading/writing pointer of the second image frame.

The second image processor 400 sequentially reads the recorded moving image frames of the switched channel using the reading pointer of the second image frame, and displays the read moving image frames on the screen.

Therefore, a first image formed prior to the channel switching and a second image formed after the channel switching are simultaneously displayed on the screen during the channel switching operation.

The controller 100 controls the window synthesizer 600 to integrate the first/second images into a single image using a sliding method.

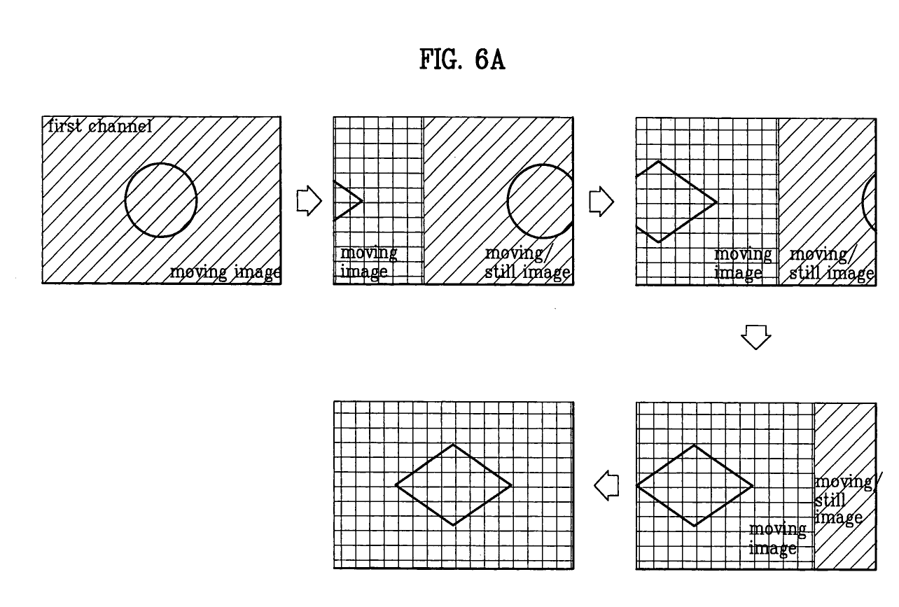

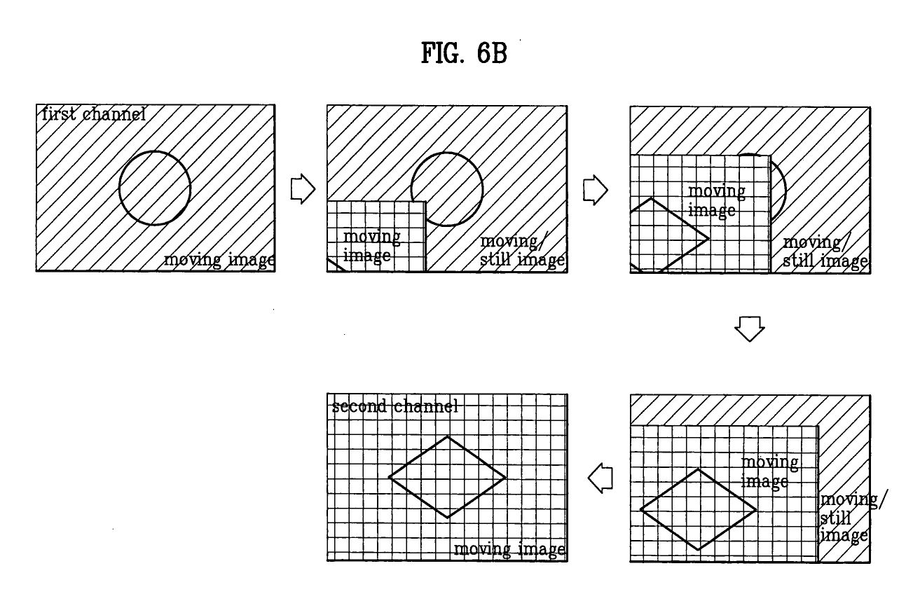

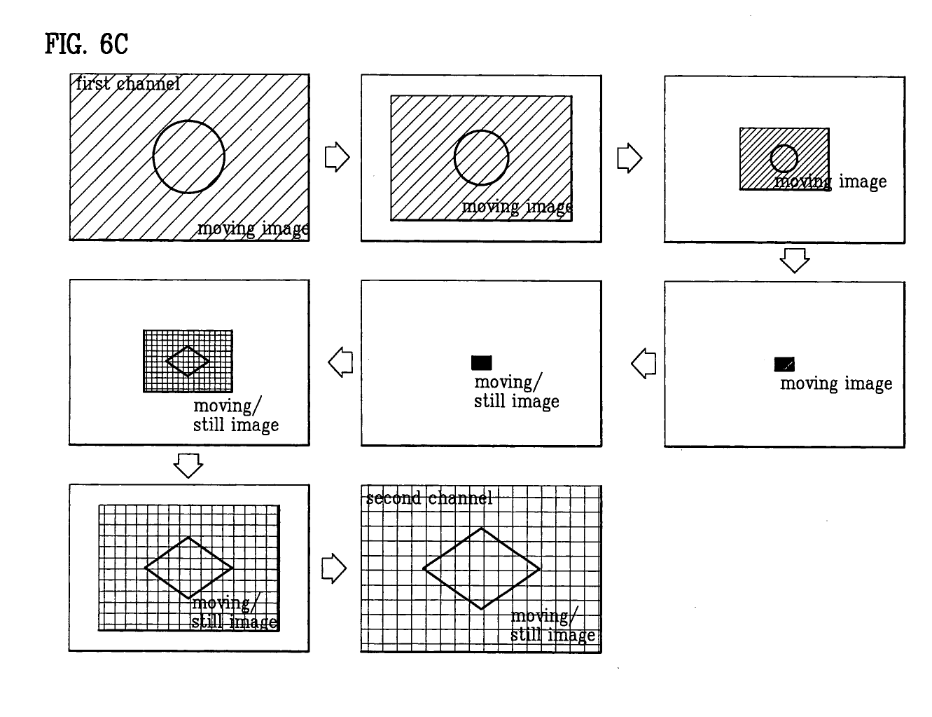

FIGS. 6A to 6C show a variety of preferred embodiments associated with the channel switching method according to the present invention.

FIG. 6A shows a variation example of an image displayed when a user who views a program of the first channel desires to view a program of the second channel.

As can be seen from FIG. 6A, a first image formed prior to the channel switching and a second image formed after the channel switching are sequentially slid in a direction from the left side to the right side at a user's viewpoint at which the user views the screen, such that the first image and the second image are sequentially displayed on the screen.

As can be seen from FIG. 6B, if a first channel is switched to a second channel, the image of the second channel is gradually changed according to a sliding method from a one-sided edge of the screen.

The switching type shown in FIG. 6B is made available on the condition that the controller changes input positions (x,y) to other positions.

As can be seen from FIG. 6C, if a first channel is switched to a second channel, the image of the first channel is gradually decreased (i.e., a fade-out operation), and then the image of the second channel is gradually increased (also called a fade-in operation), such that the channel switching operation is performed using the fade-in operation and the fade-out operation.

As apparent from the above description, an apparatus and method for switching a channel of a digital TV according to the present invention provides a channel switching method for allowing a window to be slid, resulting in minimization of a user eyestrain caused by a channel switching operation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for switching a channel of a digital television, comprising:
a image processor for performing scaling of image data input to match an output image size;
a frame storage unit for storing the image frames scaled by the image processor; and
a controller for allowing a image frame of a first channel and a image frame of a second channel scaled by the image processor to be displayed as a single image.

2. An apparatus for switching a channel of a digital television, comprising:
a first image processor for performing scaling of first video data of a first channel to match an output image size, and generating the first video data in the form of a plurality of first image frames;
a second image processor for performing scaling of second video data of a switched channel, and generating the second video data in the form of a plurality of second image frames;
a frame storage unit for storing the first image frames scaled by the first image processor and the second image frames scaled by the second image processor; and
a controller for allowing a first image frame scaled by the first image processor and a second image frame scaled by the second image processor to be displayed as a single image.

3. The apparatus according to claim 2, further comprising:
a window synthesizer for synthesizing the scaled first image frame and the scaled second image frame in a single image, and generating the synthesized image.

4. The apparatus according to claim 3, wherein the synthesized image generated from the window synthesizer includes a first image indicative of one of a moving image and a still image.

5. The apparatus according to claim 3, wherein the synthesized image generated from the window synthesizer includes a second image indicative of one of a moving image and a still image.

6. The apparatus according to claim 3, wherein the synthesizing of the window synthesizer for synthesizing the first image and the second image is implemented with a sliding method by which the first image and the second image are slid.

7. The apparatus according to claim 3, wherein the synthesizing of the window synthesizer for synthesizing the first image and the second image is implemented with a fade-in and fade-out method by which the first image is faded out and the second image is then faded in.

8. The apparatus according to claim 2, wherein the first image processor stores the first image frames in the frame storage unit using a first image writing pointer.

9. The apparatus according to claim 2, wherein the first image processor reads the first image frames stored in the frame storage unit using a first image reading pointer, and displays the read first image frames.

10. The apparatus according to claim 2, wherein the second image processor stores the second image frames in the frame storage unit using a second image writing pointer.

11. The apparatus according to claim 2, wherein the second image processor reads the second image frames stored in the frame storage unit using a second image reading pointer, and displays the read second image frames.

12. The apparatus according to claim 2, wherein the controller controls I/O (Input/Output) position information, I/O size information of a first image frame and a second image frame, and writing/reading pointers of a first image and a second image, such that the first image and the second image are displayed on a single screen.

13. A method for switching a channel of a digital television, comprising the steps of:
(a) performing scaling of first video data of a current channel to match an output image size, and storing the first video data in the form of a plurality of first image frames;
(b) performing scaling of second video data of a switched channel, and storing the second video data in the form of a plurality of second image frames; and
(c) synthesizing one of the first image frames and one of the second image frames, and displaying the synthesized image.

14. The method according to claim 13, wherein the synthesizing at the step (c) is implemented with a sliding method by which the first image and the second image are slid.

15. The method according to claim 13, wherein the synthesizing at the step (c) is implemented with a fade-in and fade-out method by which the first image is faded out and the second image is then faded in.

16. The method according to claim 13, wherein the synthesizing at the step (c) is implemented by synthesizing a still first image frame and a still second image frame.

17. The method according to claim 13, wherein the synthesizing at the step (c) is implemented by synthesizing moving first image frames temporally changed from among the first image frames and a still second image frame.

18. The method according to claim 13, wherein the synthesizing at the step (c) is implemented by synthesizing a still first image frame and moving second image frames temporally changed.

19. The method according to claim 13, wherein the synthesizing at the step (c) is implemented by synthesizing a moving first image frames temporally changed and moving second image frames temporally changed.
